(19) United States
(12) Patent Application Publication
(10) Pub. No.: US 2010/0034345 A1
(43) Pub. Date: Feb. 11, 2010

(54) Radiation converter and method for producing the same, radiation detector and tomography device

(76) Inventors: Björn Heismann, Erlangen (DE); Stefan Wirth, Erlangen (DE)

Correspondence Address: HARNESS, DICKEY & PIERCE, P.L.C., P.O.BOX 8910, RESTON, VA, 20195, US

(21) Appl. No.: 12/461,186

(22) Filed: Aug. 4, 2009

(30) Foreign Application Priority Data
Aug. 5, 2008 (DE) 10 2008 036 449.5

(51) Int. Cl. G21K 1/12; B32B 37/00; G21K 1/02; G01N 23/06

(52) U.S. Cl. 378/19; 156/293; 156/297; 378/147; 378/51; 378/21

(57) ABSTRACT

A radiation converter is disclosed. In at least one embodiment, the converter is for x-ray or gamma radiation and includes a multiplicity of scintillation elements which are separated from one another by separating septa. To reduce cross-talk between adjacent scintillation elements, the separating septa have a layer structure. The layer structure includes two backscatter layers, between which an absorber layer which is essentially opaque to the radiation, to scatter radiation and/or scintillation light is disposed.

### PRIORITY STATEMENT

The present application hereby claims priority under 35 U.S.C. §119 on German patent application number DE 10 2008 036 449.5 filed Aug. 5, 2008, the entire contents of which are hereby incorporated herein by reference.

### Field

At least one embodiment of the invention generally relates to a radiation converter for radiological radiation, in particular x-ray or gamma radiation, with a multiplicity of scintillation elements aligned in the form of a matrix in a detection plane.

### BACKGROUND

The scintillation elements are made from a scintillation material. Scintillation light is generated through interaction processes of x-ray or gamma radiation with the scintillation material. The scintillation light in turn can be converted by means of photodetection elements, such as, for example, photodiodes, into electrical signals. A two-dimensional or three-dimensional representation of an object under investigation can be produced on the basis of the electrical signals. A detection cell formed from a scintillation element and one or more photodiodes normally forms a single picture element, or a single pixel, of the radiation converter.

In contrast to, for example, scintillation elements comprising acicular cesium iodide crystals, scintillation elements comprising, for example, gadolinium oxisulfide ceramics have isotropic propagation characteristics for the scintillation light. However, to achieve an advantageous light yield, it is known, for example, particularly in scintillation elements in which the scintillation light can propagate isotropically, for layers comprising backscattering material to be provided on side areas facing away from the photodiodes.

However, it is not possible to avoid, to an adequate extent by way of the backscattering materials, the scintillation light generated in a scintillation element penetrating adjacent scintillation elements, this phenomenon also being known by the name of “cross-talk”. The local resolution of the radiation converter is significantly impaired by the cross-talk. The impairment of the local resolution caused by the cross-talk can be restricted within certain limits, for example, through high-pass filtering of the signals.

However, further impairments occur in the aforementioned procedure, as the cross-talk also has a negative effect on the noise component in the electrical signals, this being further amplified by the high-pass filtering. The negative, noise-related effects become all the more significant as the size of the pixels is reduced—in line with the trend of technological development.

Since the backscattering effect can be improved by way of thicker backscatter layers, the cross-talk could be reduced accordingly. However, the quantum efficiency for the evidence of the radiation is reduced by thicker backscatter layers. For this reason, a compromise between detection efficiency and cross-talk is opted for in the known radiation converters, and a certain noise correlation between signals of adjacent pixels is tolerated. It is not unusual here for only around 30% of the entire generated scintillation light to be detected by the photodiodes, with around 40% being lost due to absorption losses in the scintillation material, while the remaining proportion of around 30% penetrates adjacent pixels due to cross-talk. The comparatively high, cross-talk-related proportion results in significant impairments, as described above.

### SUMMARY

In at least one embodiment of the invention, at least one disadvantage according to the prior art is reduced or even eliminated. In particular, a radiation converter is intended to be provided, in at least one embodiment, which enables a comparatively high quantum efficiency with, at the same time, significantly reduced cross-talk.

Furthermore, a method for producing a radiation converter, a radiation detector and/or a tomography device are disclosed in at least one embodiment.

A first aspect of at least one embodiment of the invention relates to a radiation converter for radiological radiation, in particular x-ray or gamma radiation. The radiation converter comprises a multiplicity of scintillation elements aligned in a detection plane. The scintillation elements are preferably aligned in the form of a matrix, whereby, in an arrangement of this type, each scintillation element or a group comprising a plurality of scintillation elements can form a picture element, or pixel, of the radiation converter.

The scintillation elements are separated from one another in one direction parallel to the detection plane by separating septa or by an integral separating septa grid. The separating septa or the separating septa grid have/has a layer structure in one direction parallel to the detection plane. Here, the term “layer structure” is understood to mean that the separating septa or the separating septa grid have/has a plurality, however at least two, layers which differ from one another. However, the possibility of two or more of the layers being made from identical or functionally identical materials should not be excluded.

The layer structure comprises at least two backscatter layers, between which at least one absorber layer essentially opaque to the radiation, to scatter radiation and/or scintillation light is disposed. The term “scatter radiation” is understood to mean a secondary radiation from the radiological radiation caused by interaction processes, e.g. by scatter processes in the scintillation element.

Thus, the following sequence can be achieved in one direction parallel to the detection plane: scintillation element—backscatter layer—absorber layer—backscatter layer—scintillation element. In this sequence, the backscatter layers face the scintillation elements. The backscatter layers can be applied to the absorber layer, for example, by lacquering, vapor deposition, spraying and/or immersion. In the context of the invention, it is particularly appropriate for a plurality of backscatter layers to be disposed in each case on both sides of the absorber layer. In this way, the backscatter efficiency can be improved, i.e. the scintillation light loss can be reduced.

If backscatter layers are suitably selected, the scintillation light generated by quantum absorption processes in the scintillation element can be optimally backscattered on the boundary area of the scintillation elements into the respective scintillation element, whereby an increased scintillation light yield can be achieved.

However, the backscatter layers as such are normally to a certain extent transparent to scintillation light. Consequently, the entire scintillation light falling on the backscatter layers would not be backscattered, so that scintillation light could penetrate the backscatter layers alone and could pass into adjacent scintillation elements.

Furthermore, the backscatter layers are normally transparent to the radiological radiation and scatter radiation. Thus, the radiation or scatter radiation could penetrate the backscatter layers alone and could generate scintillation light in adjacent scintillation elements. Cross-talk between adjacent scintillation elements can therefore occur here also. The term “cross-talk” is therefore used below in a generalized sense for both optical cross-talk and cross-talk from the radiation or scatter radiation.

According to at least one embodiment of the invention, by disposing the absorber layer which is essentially opaque to the radiation, scatter radiation and/or scintillation light between the backscatter layers, the cross-talk can be at least largely suppressed or, under certain circumstances, even avoided. A reciprocal interference and correlation of the scintillation elements can therefore be reduced, resulting in an improvement in the resolution capability.

The wording “essentially opaque to the radiation and/or scintillation light” is intended here to mean that the radiation, scatter radiation and/or scintillation light can be absorbed, i.e. the cross-talk can be reduced, at least to the extent that a mutual interference of adjacent scintillation elements is reduced to a negligible amount.

The absorber layer can be produced from any given material capable of meeting the relevant opacity requirements. To avoid optical cross-talk, the absorber layer can comprise, for example, a plastic layer which is essentially opaque to scintillation light. Other materials, such as metals and combinations of the same with e.g. plastics, are also conceivable.

The respective required opacity can, for example, also be achieved and/or additionally improved by covering the absorber layer with a coating which absorbs radiation, scatter radiation and/or scintillation light. Furthermore, the absorber layer can also be filled with particles which absorb radiation, scatter radiation and/or scintillation light.

Alternatively or additionally, it is also conceivable for the plastic layer to be filled with particles which absorb radiation and/or scintillation light.

Particularly good backscatter characteristics can be achieved if the backscatter layer comprises a material containing titanium oxide or a titanium oxide mixture.

The two backscatter layers can, for example, have a thickness ranging from 1 μm to 100 μm. The absorber layer can have a thickness ranging from 1 μm to 300 μm. If thicknesses of the backscatter and absorber layers are suitably selected in the indicated ranges, the cross-talk can be effectively suppressed with simultaneously high quantum efficiency and a high fill factor.

To further improve the backscatter, it is possible for at least one further backscatter layer to be applied to a side area of the radiation converter or scintillation elements running parallel to the detection plane. Obviously, the aforementioned side area differs from the side area of the scintillation element on which a photodetection element is to be fitted to detect the scintillation light.

A second aspect of at least one embodiment of the invention relates to a radiation detector for detecting radiological radiation, in particular x-ray or gamma radiation, comprising at least one radiation converter according to the first aspect of at least one embodiment of the invention.

A third aspect of at least one embodiment of the invention relates to a tomography device, in particular a computer tomography device, with at least one radiation detector according to the second aspect of at least one embodiment of the invention.

The advantages and advantageous effects of the second and third aspects of at least one embodiment of the invention are set out in the description of the first aspect of at least one embodiment of the invention.

A fourth aspect of at least one embodiment of the invention relates to a production method for a radiation converter according to the first aspect of at least one embodiment of the invention. The production method comprises the following steps:
a) Production of the separating septa or the separating septa grid by producing or providing the absorber layers or an absorber layer grid and by applying the backscatter layers to areas of the absorber layers or the absorber layer grid facing the scintillation element; and
b1) Production or provision of a scintillation layer made from scintillation material, which has indentations formed between adjacent scintillation elements for insertion of the separating septa or the separating septa grid, and for insertion of the separating septa or the separating septa grid into the indentations; or
b2) Filling of grid meshes of the separating septa grid with the scintillation material.

The radiation converter according to at least one embodiment of the invention can be produced in a simple and low-cost manner with the production method.

Depending on the type of scintillation material used, various possibilities exist for the filling process in step b2). If individual scintillation elements are present, for example in cuboid form, the scintillation elements can be inserted into the grid meshes.

It is also possible to introduce a scintillation material which, at least during the filling process, is in a free-flowing state, into the grid meshes. Once the filling process is completed, the free-flowing scintillation material can be cured.

It is furthermore possible to introduce a scintillation material which, at least during the filling process, is in a powdery state, into the grid meshes. Once the filling process is completed, the powdery scintillation material can be compacted if required, e.g. through vibration or compression.

As long as free spaces remain between the separating septa or separating septa grid and the scintillation elements or scintillation material, these can be filled with a compound material, for example with a compound adhesive, inter alia to improve the backscatter.

So that an improved backscatter of the scintillation light or an improved emergence of scintillation light on side areas of the detection converter running parallel to the detection plane can be achieved, respective side areas can be planarized, for example through polishing or grinding.

In particular following the planarization, photodetection elements formed to detect scintillation light can be attached to a first side area of the radiation converter running parallel to the detection plane, preferably by way of an adhesive. To increase the scintillation light yield, a further backscatter layer can be attached to a second side area lying opposite the first side area, i.e. facing away from the first side area, preferably following planarization of the same.

### BRIEF DESCRIPTION OF THE DRAWINGS

Embodiments of the invention are explained below with reference to figures, in which:

FIG. 1 shows schematically an x-ray computer tomography device as an example of a tomography device according to an embodiment of the invention;

FIG. 2 shows a section of a radiation converter according to the first aspect of an embodiment of the invention;

FIG. 3 shows a cutaway view of the section of the radiation converter shown in FIG. 2.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and. “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In the figures, identical or functionally identical elements are denoted throughout with the same reference symbols. The views in the figures are schematic and not true to scale, and scales may vary between the figures. Without restricting the generality, embodiments of the invention are described below with reference to x-ray computer tomography.

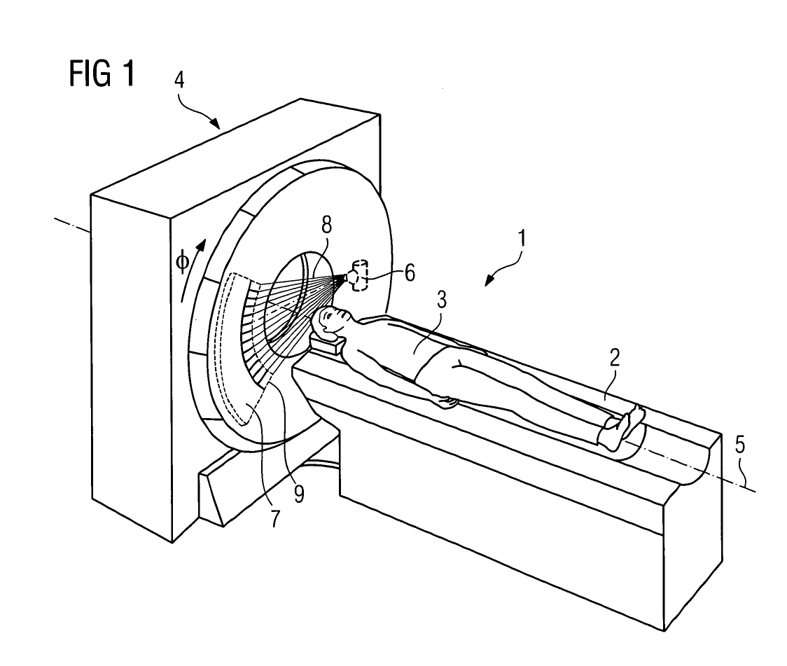

FIG. 1 shows schematically an x-ray computer tomography device 1, comprising a patient-positioning table 2 to position a patient 3 under investigation. The x-ray computer tomography device 1 furthermore comprises a gantry 4, with a tube-detector system which is mounted so that it can be rotated in azimuthal direction φ around a system axis 5. The tube-detector system in turn comprises an x-ray tube 6 and an x-ray detector 7 disposed opposite to said x-ray tube.

In the operation of the x-ray computer tomography device 1, x-ray radiation 8 passes from the x-ray tube 6 in the direction of the x-ray detector 7 and is detected by way of the x-ray detector 7. The x-ray detector 7 has a plurality of radiation detector modules 9 to detect the x-ray radiation 8.

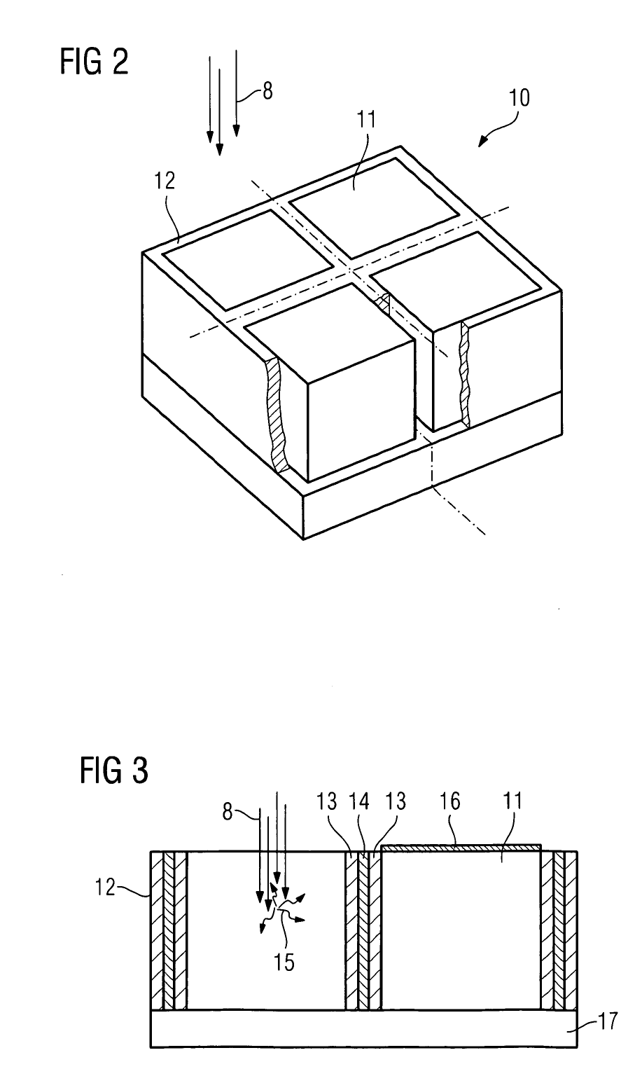

Each of the radiation detector modules 9 comprises at least one radiation detector. A section of a radiation converter, which is denoted in its entirety with reference number 10, is shown in a perspective, partially exposed view, in FIG. 2.

The radiation converter 10 comprises a multiplicity of scintillation elements 11, of which only four are shown in FIG. 2. The scintillation elements 11 are aligned in the form of a matrix in a detection plane which, in the illustration, runs perpendicular to the incident x-ray radiation 8. Without restricting the generality, each scintillation element 11 is a component of a picture element or pixel.

The scintillation elements 11 are separated from one another in one direction parallel to the detection plane by a separating septa grid 12. In the present design, the separating septa grid 12 is designed as an integral grid. However, it is also possible for the scintillation elements 11 to be separated from one another by individual separating septa running parallel to the detection plane in one or in two directions. It should be noted that a combination of a separating septa grid 12 and individual separating septa, which are provided in each case, for example, in sections only, is also possible. A detailed illustration of individual separating septa is not provided, whereby the following descriptions relating to the structure of the separating septa grid 12 apply accordingly to individual separating septa.

The separating septa grid 12 has a layer structure which is not shown in detail in FIG. 2. The layer structure is illustrated in detail in FIG. 3, which shows a cutaway view of the section of the radiation converter 10 shown in FIG. 2.

The separating septa grid 12 has a layer structure, in which an absorber layer 14 is disposed between two backscatter layers 13.

The function of the radiation converter with the backscatter layers 13 and the absorber layer 14 is as follows:

Scintillation light 15, which can propagate in the scintillation element 11 essentially in any given directions, i.e. isotropically, is generated through absorption processes of the x-ray radiation 8 in the scintillation element 11. Thus, the scintillation light 15, with reference to the illustration in FIG. 3, can propagate upwards, downwards and to the left, to the right, etc. The scintillation light 15 could therefore emerge from all side areas of a scintillation element 11 without further measures.

However, emergence of the scintillation light 15 is required only on the side area on which a photodetection element 16 is fitted to detect the scintillation light 15. For the sake of clarity, only one photodetection element 16 is shown in FIG. 3. The photodetection element 16 is fitted on an upper side area of the scintillation element 11, i.e. downstream of the scintillation element 11. It should be noted that the photodetection element can also be fitted downstream of the scintillation element 11 in accordance with the intended use of the radiation converter 10, but this is not described in further detail.

On the side areas running perpendicular to the detection plane, in the present case parallel to the incident x-ray radiation 8, the backscatter layers 13 effect a backscatter of the scintillation light 15. The probability that the scintillation light 15 generated in a scintillation element 11 will be detected by the photodetection element 16 assigned to the scintillation element 11 can at least be increased as a result. Consequently, the quantum efficiency of the radiation converter can also be improved. A further backscatter layer 17 fitted to the lower side area of the scintillation elements 11 and designed in the present example as a continuous backscatter layer acts in a similar manner. The further backscatter layer can, but does not have to, comprise a layer structure analogous to the backscatter layers 13.

In particular, the probability that the scintillation light 15 generated in a scintillation element 11 will penetrate an adjacent scintillation element 11 and will be detected by the photodetection element 16 allocated to the adjacent scintillation element 11 can therefore at least be reduced due to the backscatter layers 13. As already mentioned, said phenomenon is also known by the name of cross-talk. Due to cross-talk, not only is the local resolution of the radiation converter 10 substantially impaired, but additional noise is also generated which is detrimental to the quality of the images generated from signals of the photodetection elements 16.

Image quality in particular can be improved by reducing cross-talk and by increasing quantum efficiency. The possibility of improving image quality can also be exploited in that the patient dose to be administered in order to produce an image can be reduced.

Backscatter layers between the scintillation elements 11 are already used for the aforementioned purposes in radiation converters known from the prior art. However, the cross-talk can only be suppressed to an inadequate extent with these converters. The backscatter layers are normally transparent to a certain extent to scintillation light 15. In addition, the thickness of the backscatter layers cannot be freely selected with a view to the highest possible fill factor. This causes a significant reciprocal interference of adjacent pixels, resulting in a severe disadvantage, particularly in terms of the technologically-related reduction in pixel size.

These disadvantages are suppressed at least as far as possible according to the invention by disposing an absorber layer 14 between the backscatter layers 13. The absorber layer 14 is essentially opaque at least to the scintillation light 15. The term “essentially opaque” is intended to mean that the reciprocal interference of adjacent pixels is negligible.

It should be noted that a reciprocal interference of adjacent pixels, which results in a correlation of the respective signals, can also be produced in that scatter radiation generated by interaction processes of the x-ray radiation 8 with the scintillation material of the scintillation elements 11, or x-ray radiation itself, penetrates adjacent scintillation elements 11, where it generates scintillation light 15. So that processes of this type, which, in the context of the present invention, are similarly intended to be included in the term “cross-talk”, can also be at least largely suppressed, it is possible that the absorber layer 14 is furthermore essentially opaque to the x-ray radiation 8 or the scatter radiation generated by the x-ray radiation 8.

Due to the layer structure, a minimum loss of scintillation light 15 can be achieved, whereby an advantageous local resolution and an improved noise behavior can simultaneously be achieved. The latter means in particular that, compared with conventional radiation converters, the modulation transmission function and the noise transmission spectrum of the radiation converter can be significantly improved. Tomographic images produced using the radiation converter according to the invention therefore reveal in particular comparatively less noise. Less noise in turn means, for example, an improved ability to diagnose comparatively small abnormalities, e.g. of body tissue and the like.

The separating septa grid 12 can be produced particularly simply and economically if the absorber layer comprises an essentially opaque plastic layer. For example, an absorber layer grid can initially be produced from plastic, for example through an injection molding process, to which the backscatter layers 13 can then be applied. The backscatter layers 13 can be applied, for example, through lacquering, vapor deposition, immersion and/or spraying. The backscatter layers 13 can have thicknesses between 1 μm and 10 μum; and the thickness of the absorber layer 14 can be between 1 μm and 300 μm.

To further improve the absorption properties of the absorber layer 14—for scintillation light 15, x-ray radiation 8 or scatter radiation—particles with corresponding absorption behavior can be added to the absorber layer 14.

For the backscatter layers 13, a particularly advantageous backscatter of scintillation light 15 can be achieved if the layers include a titanium oxide or a mixture including titanium oxide.

There are various possibilities for producing the radiation converter 10.

Thus, for example, a scintillation layer can be produced into which indentations can be introduced, for example by sawing or by other methods. A prefabricated separating septa grid 12 or individual separating septa can be inserted into the indentations.

It is also possible for the separating septa grid 12 to be filled with scintillation material. There are in turn various possibilities for the filling process. A first possibility consists in inserting individual scintillation elements 11, for example individual scintillation elements 11 in parallelepiped or cuboid form, into grid meshes of the separating septa grid 12. In this case, the separating septa grid 12 is fitted following its production with individual, prefabricated scintillation elements 11. Second and third possibilities entail filling the grid meshes of the separating septa grid 12 with a free-flowing or powdery scintillation material. Here, the scintillation material can be cured or compacted after filling, e.g. through compression or vibration.

Free spaces between the separating septa grid 12 and the scintillation material which remain following the filling or insertion can, for example, be filled with compound adhesive to avoid scatter centers and backscatter losses.

To further improve the backscatter, in particular the backscatter of the further backscatter layer, and to avoid scatter losses in the transition of the scintillation light 15 from the scintillation element 11 to the photodetection element 16, the side areas of the scintillation elements 11 running parallel to the detection plane can, for example, be planarized. Analogously, further side areas of the scintillation elements 11 can also be planarized, insofar as use is made of the aforementioned first possibility.

Overall, the radiation converter 10 according to an embodiment of the invention offers a plurality of advantages, such as, for example, an improvement in the modulation transmission function and the noise transmission spectrum. With the proposed production method, the radiation converter 10 can be produced particularly effectively and economically.

It therefore becomes clear that the underlying object of the invention is achieved.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation converter for radiological radiation, in particular x-ray (8) or gamma radiation, comprising:
a multiplicity of scintillation elements aligned in a detection plane, preferably in the form of a matrix; and
either
separating septa to separate the scintillation elements in one direction parallel to the detection plane; or
an integral separating septa grid to separate the scintillation elements in one direction parallel to the detection plane, the at least one of the separating septa and an integral separating septa grid including a layer structure with an absorber layer disposed between at least two backscatter layers, the layer structure being essentially opaque to the radiation to scatter at least one of the radiation and scintillation light.

2. The radiation converter as claimed in claim 1, wherein the absorber layer comprises a plastic layer essentially opaque to scintillation light.

3. The radiation converter as claimed in claim 1, wherein the absorber layer at least one of
includes a coating which absorbs at least one of radiation, scatter radiation and scintillation light, and
is filled with particles which absorb at least one of radiation, scatter radiation and scintillation light.

4. The radiation converter as claimed in claim 1, wherein at least one of the at least two backscatter layers comprises a material containing titanium oxide or a titanium oxide mixture.

5. A radiation detector for detecting radiological radiation, comprising at least one radiation converter as claimed in claim 1.

6. A tomography device, comprising at least one radiation detector as claimed in claim 5.

7. A production method for a radiation converter, comprising:
producing at least one of a separating septa and a separating septa grid by producing or providing absorber layers or an absorber layer grid, and by applying backscatter layers to areas of the absorber layers or the absorber layer grid facing a scintillation element; and
either
producing or provisioning a scintillation layer made from scintillation material, including indentations formed between adjacent scintillation elements for insertion of the separating septa or the separating septa grid, and inserting the separating septa or the separating septa grid into the indentations; or
filling grid meshes of the separating septa grid with the scintillation material.

8. The production method as claimed in claim 7, wherein the filling of the grid meshes comprises inserting individual scintillation elements into the grid meshes.

9. The production method as claimed in claim 7, wherein the filling comprises inserting, into the grid meshes, a scintillation material which, at least during the filling process, is in a free-flowing state.

10. The production method as claimed in claim 7, wherein the filling comprises inserting, into the grid meshes, a scintillation material which, at least during the filling process, is in a powdery state.

11. The production method as claimed in claim 7, wherein free spaces remaining between the separating septa or the separating septa grid and the scintillation elements or the scintillation material are filled with a compound material.

12. The production method as claimed in claim 7, wherein at least one of the side areas of the scintillation elements running parallel to the detection plane is in each case planarized.

13. The production method as claimed in claim 7, wherein at least one photodetection element, designed to detect scintillation light, is in each case attached to a first side area of the scintillation elements which, in each case, runs parallel to the detection plane.

14. The production method as claimed in claim 13, wherein a further backscatter layer is applied to second side areas, in each case lying opposite the first side areas.

15. The radiation converter as claimed in claim 1, wherein the radiation converter is for x-ray or gamma radiation.

16. The radiation converter as claimed in claim 2, wherein the absorber layer at least one of
includes a coating which absorbs at least one of radiation, scatter radiation and scintillation light, and
is filled with particles which absorb at least one of radiation, scatter radiation and scintillation light.

17. A radiation detector for detecting x-ray or gamma radiation, comprising at least one radiation converter as claimed in claim 1.

18. An x-ray computer tomography device, comprising at least one radiation detector as claimed in claim 17.

19. The production method as claimed in claim 11, wherein free spaces remaining between the separating septa or the separating septa grid and the scintillation elements or the scintillation material are filled with a compound adhesive.

20. The production method as claimed in claim 8, wherein free spaces remaining between the separating septa or the separating septa grid and the scintillation elements or the scintillation material are filled with a compound material.
